(19) United States
(12) Patent Application Publication
(10) Pub. No.: US 2004/0092257 A1
(43) Pub. Date: May 13, 2004

(54) Scalable satellite area coverage

(76) Inventors: Kirby J. Chung, San Jose, CA (US); Michael Fashano, Canyon Lake, CA (US)

Correspondence Address: J.E. Kosinski, Loral Space & Communications, Ltd., Suite 303, 655 Deep Valley Drive, Rolling Hillas Estates, CA, 90274, US

(21) Appl. No.: 10/292,140

(22) Filed: Nov. 12, 2002

(51) Int. Cl. H04B 7/185; H04Q 7/20

(52) U.S. Cl. 455/429; 455/13.3; 370/316

(57) ABSTRACT

A system and method of providing scalable beam coverage for satellite communications to ground terminals. A single antenna being adapted to provide an adjustable range of narrow to wide area coverage is provided and a density of ground terminals in the coverage area is determined. A required total beam data rate is determined and the antenna is adjusted to generate single or multiple beams of variable beamwidths that correspond to the field of view required and the transmitted power and linearity are adjusted to the proper levels as determined from the density of ground terminals and required total beam data rate. The required total beam data rate capacity remains essentially constant over the adjustable range of narrow to wide area coverage.

### BACKGROUND OF THE INVENTION

1. Field of the Invention

The present invention generally relates to satellite communications and in particular to scalable beam coverage for satellite communications.

2. Brief Description of Related Developments

The amount of data that a satellite can relay from one location to another is critical to a business intending to provide such services. In actual use, the amount of data relayed is determined by the quantity of users connected to the satellite and their data transmission capabilities. Thus, the data capacity that the satellite must support can vary as a function of the geographical field-of-view of the satellite since the density, or quantity in a defined area, of users can vary. For example, a densely populated urban city may have many more users than an isolated farming community per square mile. In general, the required amount of data per unit time (data rate) is proportional to the number of users. Furthermore, populations change over time such that a formerly low density area may increase in population during the lifetime of the satellite. The reverse in population trend may also occur.

One solution to accommodating the user distribution over a wide coverage area whether for demographic, business growth, or any other reason, is to provide multiple fixed narrow coverage beams that can be placed adjacent to, or near each other, so as to fill the intended area. The total radiated signal power, gain-to-temperature ratio, and bandwidth in each beam determines the number of users and data rates that can be supported within that beam's coverage area. However each narrow beam is fixed in its coverage and power and may not be optimized for varying terminal densities over time. This results in excess or not enough data capacity and a difficult business plan.

### SUMMARY OF THE INVENTION

The present invention is directed to a method of providing scalable beam coverage for satellite communications to ground terminals. In one embodiment, the method comprises providing a single antenna being adapted to provide an adjustable range of narrow to wide area coverage, determining a density of ground terminals in the coverage area, determining a required total beam data rate and adjusting the antenna to generate single or multiple beams of variable beamwidths that correspond to the field of view required as determined from the density of ground terminals and required total beam data rate. The required total beam data rate capacity remains essentially constant over the adjustable range of narrow to wide area coverage.

In one aspect, the present invention is directed to a system for providing scalable beam coverage in a satellite communication system. In one embodiment the system comprises at least one user terminal in an area of desired coverage, the area having an associated terminal density and a satellite having at least one adjustable beamwidth antenna. The antenna is adapted to provide a wide beam over an area with a low terminal density and a narrow beam over an area with a high terminal density. The antenna is also adapted to provide a required carrier to noise interference level to each user terminal over a range of narrow beam to wide beam.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is an illustration of a single narrow beam covering an area of high terminal density in accordance with features of one embodiment of the present invention.

FIG. 3 is an illustration of a single wide beam covering an expanded area beyond a narrow beam where the terminal density is low in accordance with features of one embodiment of the present invention.

FIG. 4 is an illustration of narrow beam coverage showing more than one narrow beam covering areas of high terminal density in accordance with features of one embodiment of the present invention.

FIG. 5 is an illustration of single wide beam coverage showing a single wide beam covering the same area as three narrow beams when terminal density is low in accordance with features of one embodiment of the present invention.

FIG. 6 is an illustration of two or more beams of varying coverages overlaying each other in accordance with features of one embodiment of the present invention.

FIG. 7 is a schematic diagram of an embodiment of a system incorporating features of the present invention.

### DETAILED DESCRIPTION OF THE PREFERRED EMBODIMENT

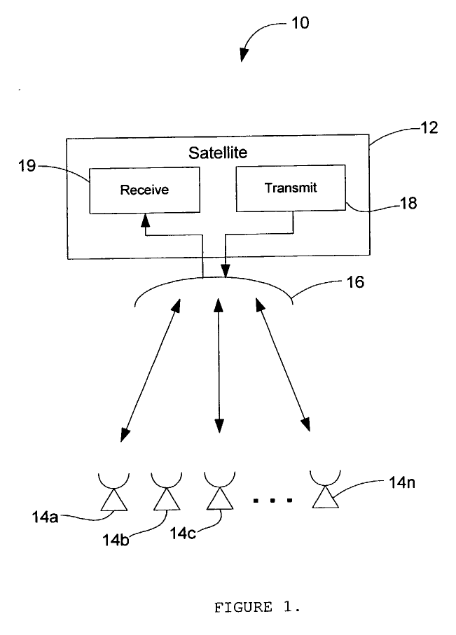

Referring to FIG. 1, there is shown a block diagram of a system 10 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1 in one embodiment, the present invention provides a scalable beam coverage area from a single antenna 16 in a satellite communications system to one or more ground terminals 14. The present invention allows the beam coverage area and transmitted power to be adjusted based on the density of the terminals 14 in the coverage area, and the required total beam data rates. It is a feature of the disclosed embodiments of the present invention to accommodate varying user densities of the covered region or regions.

Generally, the system 10 shown in FIG. 1 comprises a satellite communications system. The satellite 12 is generally adapted to provide communications coverage to one or more ground terminals 14 and generally includes one or more antennas 16 and associated transmitters 18 and receivers 19. The satellite may be in any earth orbit useful for communications by satellite including geostationary and non-geostationary orbits. The number of ground terminals 14 in any one area can vary depending on user or market requirements. The number of ground terminals 14 in any one area is generally referred to herein as “terminal density” where, a relatively large number of terminals in a defined area is an area of “high terminal density” while a relatively low number of terminals in an defined area is referred to as an area of “low terminal density.” Generally, areas of high terminal density require a high total or aggregate data rate for the given area, while areas of low terminal density require a lower total or aggregate data rate for the given area. A ground terminal 14 can generally comprise a receiver and a transmitter along with an antenna dish, although in alternate embodiments, any suitable configuration can be used.

In accordance with features of the disclosed embodiments of the present invention the satellite 12 is generally adapted to adjust or vary the data rate to a given illuminated area on the earth depending on terminal density. A single antenna 16 on the satellite 12 is used to provide a scalable beam field-of-view (“FOV”) that provides an adjustable range of narrow to wide area coverage. The FOV is determined by the terminal density or data rate and the area to be serviced. It is a feature of the present invention to hold the data capacity per user constant over the FOV range by adjusting the received antenna gain and transmitted flux density and interference levels of the satellite 12 according to the user or terminal density.

The system 10 is adapted to compensate for change in terminal density demands over a given coverage area. For example, at the start of the satellite's service the number of users in a large given coverage area may be small, that is, the density is low. In this case, the beam width may be wide to cover the large area with low density. If,, over time, the density increases as the service becomes popular the beam width may become narrower according to the data rates to be supported. Additional beams are added to overlap or be placed adjacently to equal the original large coverage area to be serviced. Also, if during the satellite's lifetime it is used from more than one orbital location, the required area of coverage may change. The antenna 16 is adapted to adjust its FOV as the terminal density demand changes. For example, if the coverage area increases and terminal density decreases, the antenna 16 automatically adjusts to provide a wide beam to replace the narrow beam. The transponder associated with the antenna 16 will adjust its transmitted power in order to maintain a required Carrier-to-Noise (C/N) at each user or terminal 14. It is a feature of the present invention that the total transponder capacity allocated to a particular antenna remain constant over the range of narrow to wide beams.

Generally, a wide beam requires more transmitted power from the satellite than a narrow beam. However, since for the wide beam not all the transponder capacity is used (since the terminal density is low) the available useful power from the transponder can be allocated to the terminal signals to obtain an appropriate power flux density to achieve the required C/N. The exact balance of signal power and interference power generated by the satellite will be system dependent. Some signal power control may also be obtained from uplink power control of the terminals.

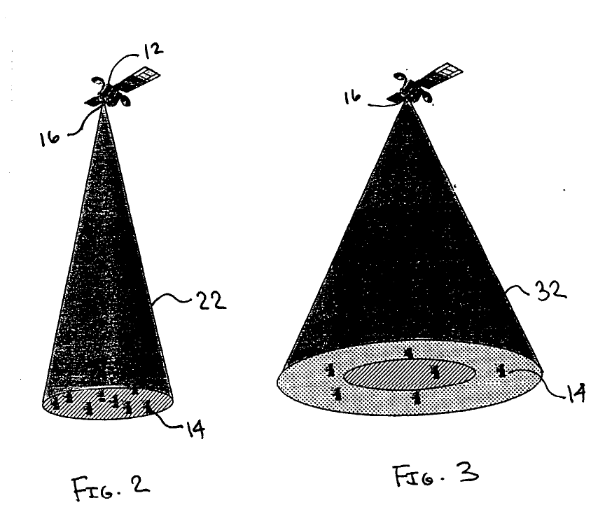

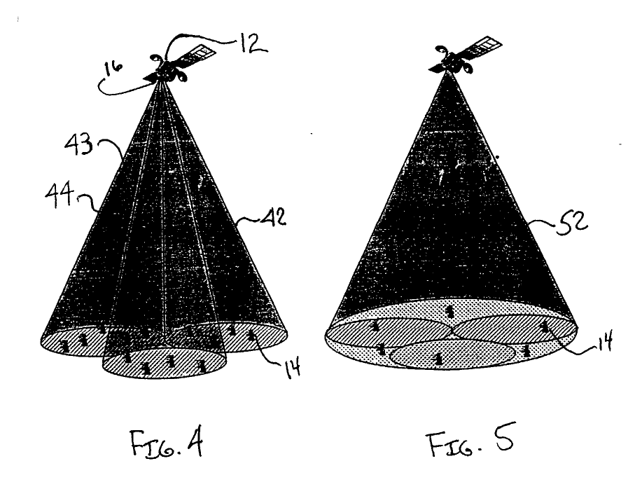

The disclosed embodiments of the present invention use the satellite antenna 16 and associated transmitter or transponder as variables in order to adjust the data rate to a given illuminated area on the earth. Generally, for a constant input power to the antenna 16, a wide beam over a low terminal density area, such as that shown in FIG. 3, will provide a lower power per unit area over the illuminated area than a narrow beam. Thus, in the present invention, the beam width of the antenna is adjustable and the transmitter power is adjustable. To do this the antenna and transmitter are electronically or mechanically variable such that the specific settings needed for the users can be commanded from the ground. Technologies that enable this capability as they are commonly known, include phased arrays and power-controllable amplifiers. When the beam width of the antenna 16 expands, as shown in FIG. 3, the transmitter power of the antenna 16 adjusts or increases to maintain the same power density (Watts/area) as provided by the narrow beam of FIG. 2. This translates into a constant data rate.

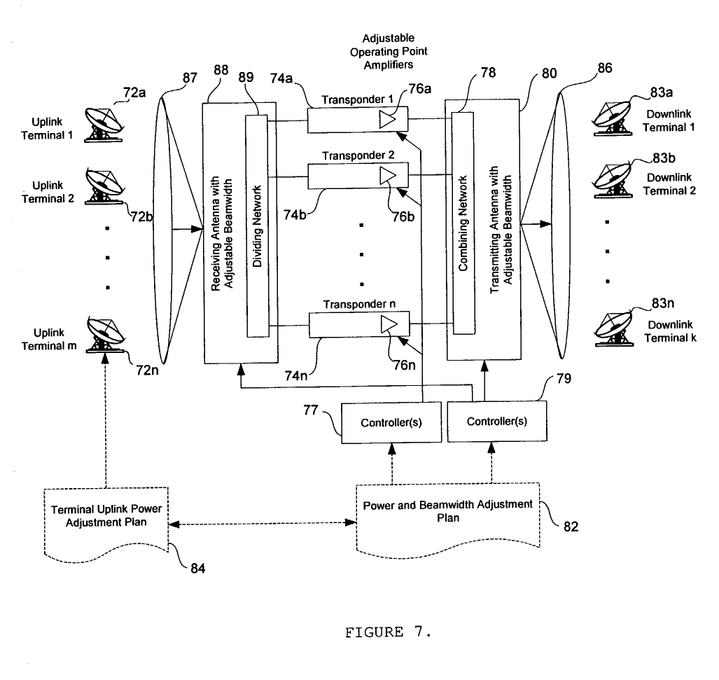

Referring to FIG. 7, a schematic of one embodiment of a system incorporating features of the present invention is illustrated. The system shown in FIG. 7 generally comprises one or more uplinks 72 that transmit or broadcast uplink signals within a receive beam 87 created by an antenna with adjustable beam width 88 that determines the size of the area of reception. The uplinks are divided and distributed by a network 89 to respective transponders 74a-n. Each transponder 74a-n routes the uplink signal to a respective amplifier 76a-n. Each amplifier 76a-n generally has adjustable operating points. The amplifier operating points, defined by the output power and linearity, are set by direct control of the amplifier circuits or by control of the input signals to the amplifier. Setting of the amplifier input can be accomplished by any suitable means, such as for example preamplifier circuits, uplink power control, internal circuitry or any combination of these. Each amplifier setting may be done independently of each other according to the needs of the terminals receiving the transmitted signals. The quantity of amplifiers and uplinks are not necessarily the same. Each transponder shown may comprise more than one signal depending on the system design.

The amplifier outputs are combined in a combining network 78 using a suitable method which may include frequency filtering, and fed into the transmitting antenna 80. The transmitting antenna 80 comprises an antenna with adjustable beamwidth and determines the size of the area to which the transmitted signals are downlinked.

The receive antenna 88 and transmit antenna 80 may be comprised of a single antenna performing both functions simultaneously or may be separate antennas. The specific implementations are system specific and technology-driven.

Controllers for the amplifiers 77 and antenna beams 79 are used to command the proper amplifier, receive antenna, and transmit antenna settings. The amplifier and antenna settings are determined by an adjustment plan 82 in the satellite or on the ground according to the data capacity requirements for user services.

If uplink power control is used a related uplink power adjustment device can also be used in the satellite or on the ground. The uplink control settings are determined by an adjustment plan 84 in the satellite or on the ground according to the data capacity requirements.

To generate several beams a plurality of such equipment sets, as shown, may be needed on each satellite. Alternatively, a single antenna capable of a plurality of simultaneous beams may be used.

In one embodiment the satellite antenna 16 shown in FIG. 1 comprises an adaptable beamwidth and beam-pointing antenna, such as for example a phased array antenna system. In alternate embodiments, any suitable antenna or antenna system can be used that has adjustable beamwidths and beam-pointing can be used for a variety of area coverage applications. The antennas may be individual receive and transmit antennas or may combine the receive and transmit functions in one antenna. It is a feature of the present invention to be able to generate a single beam of variable beamwidths for receive and transmit.

Referring to FIG. 2 in an area of high terminal density or high data capacity, the antenna 16 can be adjusted to generate a narrow beam 22 that is used with optimized transmitter power and interference levels set in the transponder associated with the beam 22. The single narrow beam is used over an area of high terminal density and can provide a guaranteed carrier to noise interference ratio (“C/N”) per user. The transmitter power and interference levels are determined according to calculations done by the system operator for the data capacity in the covered area. The calculations result in transponder settings which are commanded to the satellite. They may be constantly adjusted depending on the system operator.

Referring to FIG. 4, the satellite 12 can be capable of producing multiple beams 42, 43, 44 and can include several antennas or a single antenna 16, where the beams can be “pointed” to provide separate independent beams 42, 43, 44 to localized areas. These local areas may be contiguous or non-contiguous so as to provide high data capacity over a continuous geographical area or to provide high data capacity over geographically dispersed local areas.

Referring to FIG. 3, for areas of low terminal density or low data capacity, the antenna 16 incorporating features of the present invention can be adapted to generate a wide beam 32 that is used with optimized power and interference levels set in the transponder associated with the antenna 16. The single wide beam 32 replaces a single narrow beam, such as the beam 22 shown in FIG. 2, to provide coverage over a wide area with low terminal density while maintaining the carrier-to-noise interference ratio needed for each user 14.

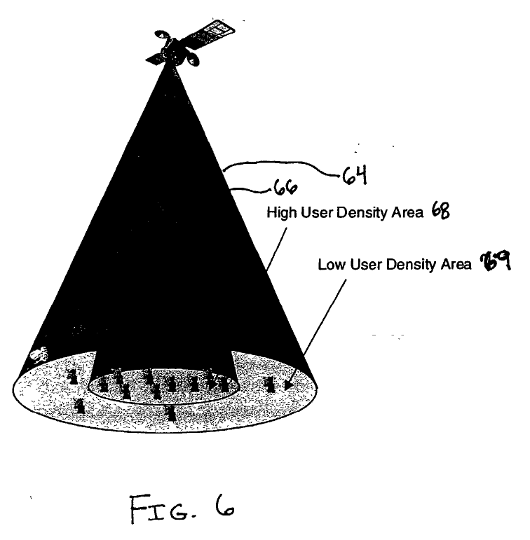

Referring to FIG. 5, a single wide beam replaces several narrow beams to provide coverage over a wider area with low terminal density while maintaining the C/N ratio needed for each user 14. If several such antennas 16 exist on the satellite 12 as shown in FIG. 5, each antenna 16 can be pointed to provide independent beams to a large area of low terminal density while maintaining the carrier-to-noise interference ratio needed for each user 14.

Referring to FIGS. 2-5, a wide beam can be used to cover the area of one or more narrow beams depending on the terminal density. In FIG. 2 the single narrow beam 22 from a single antenna 16 provides satellite communication coverage to an area of high terminal density. In FIG. 3, the same antenna 16 can be used to provide a wide beam 32 in regions where the terminal or user density is low. The data rate to each terminal 14, in both the narrow beam 22 and the wide beam 32, remains constant. The wide beam 32 may include the area of the narrow beam 22.

In FIG. 4 several narrow beams 42, 43, 44 from multiple different antennas 16 provides satellite communication coverage to areas of high terminal density. Each beam 42, 43, 44 can be independent. Alternately the three narrow beams 42, 43, 44 may be produced from a single antenna 16.

The same area size shown in FIG. 4 in a different geographic zone may have a low terminal density, where a single wide beam from a single antenna can be used to provide service to the terminals. In FIG. 5, the same antenna or antennas 16 can be used to provide a wide beam 52 where the terminal density is low. The wide beam 52 may include the areas of the narrow beams 42, 43, 44.

As shown in FIGS. 2-5 the antenna 16 adapts its beamwidth as the terminal density changes from high to low. The transponder associated with the antenna 16 also adjusts its transmitted power in order to maintain the required C/N at each user 14. Adaptability of beamwidths and transmitted power allows optimization of the satellite resources to match the data capacity for user densities which may vary with geography or at different times of the service business. For example, if a given area has low user densities at the start of the service business a wide beam may be used and then adjusted to a narrower beam as user densities increase along with the addition of more narrow beams to cover the same given area.

It is a feature of the present invention to have the antenna 16 adapt its beamwidth as terminal density demands change in addition to adapting its transmitted power to maintain a required C/N at each user. The specific design and construction techniques to adjust beamwidths and transmitter powers are well known and can take a plurality of forms. The application of combining the beamwidth and power control functions to achieve a system to adapt to varying user terminal densities and data rates is central to this invention.

Referring to FIG. 6, in one embodiment, two or more beams 64, 66 can simultaneously overlay each other. The beams can include one or more narrow beams 66 covering an area 68 of high user density and one wide beam 64 encompassing an area 69 of low user density. The narrow beams 66 can generally supply a higher data rate to a limited area 68 within the wide beam 64. The beams 64, 66 could be generated by separate antennas, or by the same antenna having additional beam forming network complexity. Each beam 64, 66 would need a separate transmitter. For example, in an application where a satellite provides communication coverage to a city having less populated outlaying areas, the narrow beam 66 could be aimed on the city and the wide beam 64 covering the suburbs.

The present invention allows a single antenna to be used for a variety of area coverage applications and increase the flexibility of the satellite. The total satellite data capacity per user remains constant whether the antenna provides a narrow beam for high terminal density or a wide beam for low terminal density. The system can generally be used to accommodate varying user densities. Using a zoomable antenna and variable transmitter power, the coverage area and power density, and thus, the data rate, can be adjusted according to market demand.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of providing scalable beam coverage for satellite communications to ground terminals, the method comprising the steps of:
providing a single antenna being adapted to provide an adjustable range of narrow to wide area coverage;
determining a density of ground terminals in the coverage area;
determining a required total beam data rate; and
adjusting the antenna to generate single or multiple beams of variable beamwidths that correspond to the field of view required as determined from the density of ground terminals and required total beam data rate, wherein the required total beam data rate capacity remains essentially constant over the adjustable range of narrow to wide area coverage.

2. The method of claim 1 wherein a total satellite transponder capacity per user for a particular antenna is a constant over a range of narrow to wide beams.

3. The method of claim 1 further comprising the step of adjusting the field-of-view of the antenna as terminal density demands change.

4. The method of claim 1 further comprising the step of adjusting a transmitted power and linearity of a transponder in order to maintain a required C/N at each user, wherein the transmitter power and linearity are adjusted to correspond to a change in the antenna beamwidth as the density of ground terminals changes.

5. The method of claim 1 further comprising the step of adjusting the field of view of the antennas over a range of wide area to narrow area coverage as a terminal density demand changes.

6. The method of claim 5 further comprising the step of adjusting a transmitted power and linearity associated with the antenna to correspond to the adjusting of the field of view in order to maintain a constant data capacity per user.

7. The method of claim 1 further comprising the step of obtaining signal power control from an uplink power control of the ground terminals.

8. A method of adapting a satellite communications link to user requirements in a covered region, the method comprising the steps of:
providing a first adaptable aperture antenna that can be used to generate a single beam of variable band widths;
determining a terminal density of a desired coverage area;
generating a single beam from the antenna over the area; and
adjusting a beam field of view of the single beam in a range of narrow to wide area coverage corresponding to a change in the terminal density of the desired coverage area, wherein a data rate capacity per terminal is held constant over the beam field of view.

9. The method of claim 8 further comprising the step of adjusting a the flux density and interference level of a transmitter associated with the antenna according to the terminal density.

10. The method of claim 8 further comprising, for areas of low terminal density, adapting the antenna to generate a wide beam that is used with optimized user power and interference levels.

11. The method of claim 8 further comprising, for areas of high terminal density, adapting the antenna to generate a narrow beam that is used with optimized user power and interference levels.

12. The method of claim 8 further comprising holding the data capacity per user constant over the range of narrow to wide converage by adjusting a flux density and interference level in a transmitter associated with the antenna according to the terminal density.

13. The method of claim 8 further comprising the step of holding a total satellite transponder capacity per user for a particular antenna on the satellite constant over the range of narrow to wide beams.

14. The method of claim 8 further comprising the steps of:
generating a second beam from a second adjustable beamwidth antenna on the satellite, the second beam being a wide beam when the beam from the first antenna is a narrow beam;
overlaying the second beam over the narrow beam from the first antenna; and
using the first antenna to provide a higher data rate to a limited area within the wide beam.

15. A system for providing scalable beam coverage in a satellite communication system comprising:
at least one user terminal in an area of desired coverage, the area having an associated terminal density;
a satellite having at least one adjustable beamwidth antenna, the antenna being adapted to provide a wide beam over an area with a low terminal density and a narrow beam over an area with a high terminal density, the antenna being adapted to provide a required carrier to noise interference level to each user terminal over a range of narrow beam to wide beam.

16. The system of claim 15 further comprising a controller in the satellite adapted to determine a terminal density associated with the area of desired coverage and cause the antenna to adjust its field of view to correspond to the terminal density.

17. The system of claim 15 further comprising a second adjustable beamwidth antenna, adapted to generate a second beam, the second beam being a wide beam when a first beam from a first antenna is a narrow beam, and wherein the second beam overlays the first beam, the first beam providing a higher data rate to a limited area within the second beam.

18. The system of claim 15 further comprising a transponder associated with each antenna, the transponder adapted to adjust transmitted power and linearity in order to provide a power flux density for each user terminal that remains constant over a range of wide beam to narrow beam field of view coverage.

19. The system of claim 15 further comprising:
at least one uplink terminal adapted to broadcast uplink signals within a receive beam created by a receiving antenna having an adjustable bandwidth;
a dividing network adapted to divide and distribute received uplink signals to respective transponders;
an adjustable point amplifier associated with each transponder for amplifying the received uplink signals, an amplifier operating point of each amplifier being set by direct control of input signals to each amplifier;
a combining network adapted to combine an output of each amplifier to generate a signal that is fed to a adjustable beamwidth transmitting antenna adapted to downlink the signal to respective downlink terminals.

20. The system of claim 19 wherein transmitted power and linearity of the downlink signal is adjusted by determining the density of ground terminals and a required total beam data rate and adjusting each amplifier operating point accordingly.
